(19) United States
(12) Patent Application Publication
(10) Pub. No.: US 2018/0158155 A1
(43) Pub. Date: Jun. 7, 2018

(54) PROPOSAL CANDIDATE PRESENTATION DEVICE AND PROPOSAL CANDIDATE PRESENTATION METHOD

(71) Applicant: Panasonic Intellectual Property Management Co., Ltd., Osaka (JP)

(72) Inventors: YASUKO IKETSUKI, Tokyo (JP); ATSUSHI SASO, Kanagawa (JP); YUICHI AOKI, Osaka (JP); AKIRA ASAI, Osaka (JP); MOTOJI OHMORI, Osaka (JP)

(21) Appl. No.: 15/818,747

(22) Filed: Nov. 21, 2017

(30) Foreign Application Priority Data
Dec. 6, 2016 (JP) 2016-237087

(51) Int. Cl. G06Q 50/14; G06Q 30/06; G10L 15/26; G10L 15/18; G10L 15/22

(52) U.S. Cl. CPC G06Q 50/14; G06Q 30/0631; G06N 5/02; G10L 15/1815; G10L 15/22; G10L 15/265

(57) ABSTRACT

A proposal candidate presentation device that includes: a biological reaction information generator that generates biological reaction information; a dialogue content information generator that generates dialogue content information including dialogue content between the customer and a proposer; a determiner that determines whether a customer reaction to a question from the proposer is positive or negative, based on the biological reaction information and dialogue content information; a proposal candidate generator that generates a customer proposal candidate information, based on a customer response to the question, when it is determined that the customer reaction based on the biological reaction information is positive and the customer reaction based on the dialogue content information is positive; and a re-question generator that generates first re-question information having the same perspective as the question, when the customer reaction based on the biological reaction information and the customer reaction based on the dialogue content information do not match.

### BACKGROUND

### 1. Technical Field

The present disclosure relates to a proposal candidate presentation device, a proposal candidate presentation method, and a recording medium having recorded thereon a proposal candidate presentation program, which present proposal candidate information including at least one proposal for a customer on the basis of dialogue content including a question asked to the customer by a proposer and a response of the customer regarding the question. The present disclosure relates to a technique for presenting the proposer with proposal candidate information including a proposal that corresponds to the preferences of the customer, when the proposer carries out consulting work, concierge work, and the like with respect to the customer, face-to-face or via a predetermined network, in various facilities such as a travel agency and a hotel, for example.

### 2. Description of the Related Art

In recent years, artificial intelligence has advanced and various consulting work and concierge work such as selling work, reception work, and guidance work is being carried out using devices that employ artificial intelligence in retail stores, banks, travel agencies, hotels, medical facilities, nursing homes, schools, manufacturing plants, and various other facilities.

For example, Japanese Unexamined Patent Application Publication No. 2001-28020 discloses that the state of a user is recognized by means of a dialogue with the user via an appropriate input/output device. In addition Japanese Unexamined Patent Application Publication No. 2001-28020 discloses a travel companion device that is provided with: a dialogue-type condition extraction unit that extracts a condition relating to a trip of the user on the basis of the aforementioned recognition result; a concept deciding unit that decides the concept of the trip on the basis of the condition extracted by the dialogue-type condition extraction unit; and a plan creation unit that creates a plan for the trip in accordance with the decided concept. In this Japanese Unexamined Patent Application Publication No. 2001-28020, it is described that it is possible to easily create a trip plan capable of satisfying a traveler.

Furthermore, the following is disclosed in Japanese Unexamined Patent Application Publication No. 2011-108142. Specifically, an output screen generation unit generates an output screen that displays question information, and causes the output screen to be displayed on a user terminal and presented to a user. An information acquisition unit acquires response information indicating a response of the user regarding the question information, and biological information of the user. An information storage unit stores the question information, the response information, and the biological information corresponding to the response information, in association with each other. A response determination unit determines whether or not to carry out re-questioning on the basis of the biological information of the user corresponding to the response information. In the case where the response determination unit has determined that re-questioning is to be carried out, the output screen generation unit generates an output screen that displays re-question information, and causes the output screen to be displayed on the user terminal and presented to the user. In this Japanese Unexamined Patent Application Publication No. 2011-108142, it is described that waste is eliminated during profiling by carrying out re-questioning only for responses in situations that are different from those of past biological information or response information, and it is possible to reduce the burden of carrying out profiling many times for the user.

Furthermore, the following is disclosed in Japanese Unexamined Patent Application Publication No. 2002-108183. Specifically, a teaching material presentation means retrieves teaching material retained in a teaching material retaining means and presents the teaching material to a user in accordance with a teaching material presentation procedure retained in a teaching material presentation procedure retaining means. At such time, a user reaction observation means observes a reaction exhibited by the user, and converts the reaction into numerical information and records the numerical information as learning history in a learning history recording means. An optimum teaching material presentation procedure deciding means decides a teaching material presentation procedure for which the best reaction has been exhibited up to that point in time, as the optimum teaching material presentation procedure, on the basis of the recorded learning history. In this Japanese Unexamined Patent Application Publication No. 2002-108183, it is described that it is possible to reflect the reaction of the user that is exhibited when teaching material is presented, and to expect an improvement in the learning effect.

### SUMMARY

One non-limiting and exemplary embodiment provides a technique with which it is possible for a proposer to be presented with proposal candidate information including a proposal that corresponds to the preferences of a customer, even in the case where there is a difference between a reaction determined from a response of the customer regarding a question and a reaction determined from biological data of the customer regarding the question.

In one general aspect, the techniques disclosed here feature a proposal candidate presentation device provided with: a biological reaction information generator that acquires biological data of a customer, and generates biological reaction information including the biological data and first time information indicating a time at which the biological data was acquired; a dialogue content information generator that acquires dialogue content between the customer and a proposer, and generates dialogue content information including dialogue information indicating the dialogue content and second time information indicating a time at which the dialogue content was acquired; a countermeasure determiner that determines whether a reaction of the customer regarding a question asked by the proposer is a positive reaction or a negative reaction, based on the biological reaction information, and determines whether the reaction of the customer regarding the question is a positive reaction or a negative reaction, based on the dialogue content information; a proposal candidate generator that generates proposal candidate information indicating at least one proposal for the customer, based on a response of the customer regarding the question, in a case where it is determined that a reaction of the customer based on the biological reaction information is a positive reaction and a reaction of the customer based on the dialogue content information is a positive reaction; and a re-question generator that generates first re-question information indicating first re-question having a same perspective as a perspective of the question, in a case where the reaction of the customer based on the biological reaction information and the reaction of the customer based on the dialogue content information do not match.

General or specific aspects may be realized by an element, a device, an apparatus, a system, an integrated circuit, or a method. Furthermore, general or specific aspects may be realized by an arbitrary combination of an element, a device, an apparatus, a system, an integrated circuit, and a method.

Additional benefits and advantages of the disclosed embodiments will be apparent from the specification and figures. The benefits and/or advantages may be individually provided by the various embodiments or features disclosed in the specification and figures, and need not all be provided in order to obtain one or more of the same.

### BRIEF DESCRIPTION OF THE DRAWINGS

FIG. 1 is a block diagram depicting an example of a configuration of a proposal candidate presentation device according to an embodiment of the present disclosure;

FIG. 2 is a flowchart depicting an example of proposal candidate presentation processing carried out by the proposal candidate presentation device depicted in FIG. 1; and

FIG. 3 is a drawing depicting an example of summary information created from biological reaction information and dialogue content information.

### DETAILED DESCRIPTION

### (Findings Forming the Basis for the Present Disclosure)

In recent years, it is becoming easy to measure brain waves, heartbeats, blood pressure, gas discharged from the body, and the like. Furthermore, it is also becoming possible to measure such biological data in a noninvasive manner, and a situation now exists in which the psychological state of a customer may be understood from these measurement items. Consequently, it is becoming clear whether or not a customer is pleased with a given proposal, and whether a reaction regarding the proposal is positive or negative.

Meanwhile, there exists consulting work and concierge work in hotels and the like in which products such as trip plans are proposed and sold face-to-face or via the Internet to customers. In such work, a proposer engages in a conversation on the basis of the psychological state of a customer estimated using biological data and observes the reactions of the customer, and is thereby able to analyze the likes and dislikes (the preferences) of that customer, and to make a proposal that is suitable for the preferences. In this case, it is necessary to accurately judge what kind of preferences a customer has and for these to be linked to the optimum proposal.

However, depending on the customer, there may be cases where there are differences or inconsistencies between reactions determined from responses to the same question and reactions determined from biological data. Meanwhile, in the techniques disclosed in Japanese Unexamined Patent Application Publication Nos. 2001-28020, 2011-108142, and 2002-108183, only biological information is simply used, and no investigation whatsoever is carried out into the case where there is a difference between a reaction determined from a response of a customer regarding a question and a reaction determined from biological data of the customer regarding the question. Therefore, it is not possible to carry out an appropriate countermeasure whatsoever for the case where there is a difference between a reaction determined from a response of a customer regarding a question and a reaction determined from biological data of the customer regarding the question.

Based on the aforementioned findings, the inventors of the present application carried out a diligent investigation into a countermeasure for the case where there is a difference between a reaction determined from a response of a customer regarding a question and a reaction determined from biological data of the customer regarding the question. As a result, the present disclosure was completed.

A proposal candidate presentation device according to an aspect of the present disclosure is provided with: a biological reaction information generator that acquires biological data of a customer, and generates biological reaction information including the biological data and first time information indicating a time at which the biological data was acquired; a dialogue content information generator that acquires dialogue content between the customer and a proposer, and generates dialogue content information including dialogue information indicating the dialogue content and second time information indicating a time at which the dialogue content was acquired; a countermeasure determiner that determines whether a reaction of the customer regarding a question asked by the proposer is a positive reaction or a negative reaction, based on the biological reaction information, and determines whether the reaction of the customer regarding the question is a positive reaction or a negative reaction, based on the dialogue content information; a proposal candidate generator that generates proposal candidate information indicating at least one proposal for the customer, based on a response of the customer regarding the question, in a case where it is determined that a reaction of the customer based on the biological reaction information is a positive reaction and a reaction of the customer based on the dialogue content information is a positive reaction; and a re-question generator that generates first re-question information indicating first re-question having a same perspective as a perspective of the question, in a case where the reaction of the customer based on the biological reaction information and the reaction of the customer based on the dialogue content information do not match.

According to a configuration such as this, biological data of the customer at a time when the proposer asks a question to the customer is acquired, and biological reaction information including the acquired biological data and biological time information indicating the time at which the biological data was acquired is generated. Together therewith, dialogue content between the customer and the proposer at a time when the proposer asks the question to the customer is acquired, and dialogue content information including dialogue information indicating the acquired dialogue content and dialogue time information indicating the time at which the dialogue content was acquired is generated. Furthermore, whether the reaction of the customer regarding the question is a positive reaction or a negative reaction is determined on the basis of the biological reaction information. Together therewith, whether the reaction of the customer regarding the question is a positive reaction or a negative reaction is determined on the basis of the dialogue content information. In the case where, as determination results, the reaction of the customer based on the biological reaction information is a positive reaction and the reaction of the customer based on the dialogue content information is a positive reaction, proposal candidate information based on the response of the customer regarding the question asked to the customer by the proposer is generated.

Consequently, in the case where the reaction of the customer based on the biological reaction information and the reaction of the customer based on the dialogue content information are both positive reactions, it is possible for an item that is liked by the customer to be reliably determined from the response of the customer regarding the question asked to the customer by the proposer. In addition, by generating proposal candidate information based on this response of the customer, proposal candidate information including a proposal that is liked by the customer can be appropriately presented to the proposer.

Furthermore, in the case where, as determination results, the reaction of the customer based on the biological reaction information and the reaction of the customer based on the dialogue content information do not match, first re-question information representing first re-question having the same perspective as that of the question included in the dialogue content is generated.

Consequently, the proposer is able to carry out first re-question having the same perspective using the first re-question information, even in the case where the reaction of the customer based on the biological reaction information and the reaction of the customer based on the dialogue content information do not match, and an item liked by the customer cannot be accurately determined from the response of the customer regarding the question asked to the customer by the proposer. Thus, it is possible for an item that is liked by the customer to be accurately determined from a response of the customer regarding the first re-question having the same perspective, in the case where a reaction of the customer based on biological reaction information and a reaction of the customer based on dialogue content information regarding this first re-question are both positive reactions. In addition, proposal candidate information including a proposal that is liked by the customer can be appropriately presented to the proposer.

As a result, proposal candidate information including a proposal that corresponds to the preferences of the customer can be presented to the proposer even in the case where there is a difference between a reaction determined from a response of the customer regarding a question and a reaction determined from biological data of the customer regarding the question.

The aforementioned proposal candidate presentation device may be further provided with a proposal candidate storer that stores the proposal candidate information, which is set in advance with respect to the question, and the proposal candidate generator may extract the proposal candidate information that has been set with respect to the question, from the proposal candidate storer, in a case where it is determined that the reaction of the customer based on the biological reaction information is a positive reaction and the reaction of the customer based on the dialogue content information is a positive reaction.

According to a configuration such as this, proposal candidate information that has been set with respect to a question asked to the customer by the proposer is extracted from the proposal candidate storer in the case where the reaction of the customer based on the biological reaction information is a positive reaction and the reaction of the customer based on the dialogue content information is a positive reaction. It is thereby possible to extract and present proposal candidate information including a proposal which is suitable for an item that is liked by the customer, assumed from the response of the customer regarding the question asked to the customer by the proposer.

The proposal candidate presentation device may be further provided with a question storer that stores, in association with each other, question information indicating each of a plurality of questions including the question, and attribute information indicating a perspective of each of the plurality of questions, and the re-question generator may extract the question information associated with the attribute information indicating a same perspective as the perspective of the question, from the stored question information as the first re-question information, in a case where the reaction of the customer based on the biological reaction information and the reaction of the customer based on the dialogue content information do not match.

According to a configuration such as this, question information having associated therewith attribute information indicating the same perspective as the perspective of the question included in the dialogue content is extracted from the stored question information as the first re-question information in the case where the reaction of the customer based on the biological reaction information and the reaction of the customer based on the dialogue content information do not match. Thus, first re-question information having attribute information having the same perspective as that of the question asked to the customer by the proposer can be presented to the proposer even in the case where an item liked by the customer cannot be accurately determined from a response of the customer regarding the question asked to the customer by the proposer. Consequently, an item that is liked by the customer can be accurately determined from the response of the customer regarding the first re-question having the same perspective.

In the aforementioned proposal candidate presentation device, a degree of similarity indicating a mutual similarity may be set between the respective perspectives of the attribute information, and the re-question generator may decide the attribute information having the degree of similarity that is equal to or greater than a predetermined value with respect to the perspective of the question, as the attribute information indicating the same perspective as the perspective of the question.

According to a configuration such as this, attribute information having a degree of similarity that is equal to or greater than a predetermined value with respect to the perspective of the question included in the dialogue content is decided as attribute information indicating the same perspective as the perspective of the question included in the dialogue content. It is thereby possible to extract first re-question information representing a question having a similar perspective.

In the aforementioned proposal candidate presentation device, the re-question generator may generate second re-question information indicating second re-question having a different perspective from the perspective of the question included in the dialogue content, when a case where the reaction of the customer based on the biological reaction information and the reaction of the customer based on the dialogue content information do not match has been repeated a predetermined number of times with respect to the first re-question indicated by the first re-question information.

According to a configuration such as this, second re-question information representing second re-question having a different perspective from the perspective of the question included in the dialogue content is generated when the case where the reaction of the customer based on the biological reaction information and the reaction of the customer based on the dialogue content information do not match has been repeated a predetermined number of times with respect to a question represented by the first re-question information. Thus, second re-question information having a different perspective from that of the question asked to the customer by the proposer can be presented to the proposer in the case where a state has continued in which an item that is liked by the customer cannot be accurately determined from the response of the customer regarding the question asked to the customer by the proposer. Consequently, an item that is liked by the customer can be accurately determined from the response of the customer regarding the second re-question having a different perspective.

The aforementioned proposal candidate presentation device may be further provided with a question storer that stores, in association with each other, question information indicating each of a plurality of questions including the question, and attribute information indicating a perspective of each of the plurality of questions, and the re-question generator may extract the question information associated with the attribute information indicating a different perspective from the perspective of the question, from the stored question information as the second re-question information, when a case where the reaction of the customer based on the biological reaction information and the reaction of the customer based on the dialogue content information do not match has been repeated a predetermined number of times with respect to the first re-question indicated by the first re-question information.

According to a configuration such as this, question information having associated therewith attribute information indicating a different perspective from the perspective of the question included in the dialogue content is extracted from the stored question information as second re-question information when the case where the reaction of the customer based on the biological reaction information and the reaction of the customer based on the dialogue content information do not match has been repeated a predetermined number of times with respect to the question represented by the first re-question information. Thus, second re-question information having attribute information having a different perspective from that of the question asked to the customer by the proposer can be presented to the proposer in the case where a state has continued in which an item that is liked by the customer cannot be accurately determined from the response of the customer regarding the question asked to the customer by the proposer. Consequently, an item that is liked by the customer can be accurately determined from the response of the customer regarding the second re-question having a different perspective.

In the aforementioned proposal candidate presentation device, the re-question generator may generate second re-question information indicating second re-question having a different perspective from the perspective of the question, in a case where the reaction of the customer based on the biological reaction information is a negative reaction and the reaction of the customer based on the dialogue content information is a negative reaction.

According to a configuration such as this, second re-question information representing second re-question having a different perspective from that of the question included in the dialogue content is generated in the case where the reaction of the customer based on the biological reaction information is a negative reaction and the reaction of the customer based on the dialogue content information is a negative reaction.

Consequently, the proposer is able to carry out second re-question having a different perspective using the second re-question information, even in the case where the reaction of the customer based on the biological reaction information and the dialogue content information is a negative reaction, and an item liked by the customer cannot be determined from the response of the customer regarding the question asked to the customer by the proposer. Thus, it is possible for an item that is liked by the customer to be accurately determined from a response of the customer regarding the second re-question having a different perspective, in the case where the reaction of the customer based on the biological reaction information and the reaction of the customer based on the dialogue content information regarding this second re-question are both positive reactions. Consequently, proposal candidate information including a proposal that is liked by the customer can be appropriately presented to the proposer.

The aforementioned proposal candidate presentation may be further provided with a question storer that stores, in association with each other, question information indicating each of a plurality of questions including the question, and attribute information indicating a perspective of each of the plurality of questions, and the re-question generator may extract the question information associated with the attribute information indicating a different perspective from the perspective of the question, from the stored question information as the second re-question information, in a case where the reaction of the customer based on the biological reaction information is a negative reaction and the reaction of the customer based on the dialogue content information is a negative reaction.

According to a configuration such as this, question information having associated therewith attribute information indicating a different perspective from the perspective of the question included in the dialogue content is extracted from the stored question information as the second re-question information in the case where the reaction of the customer based on the biological reaction information is a negative reaction and the reaction of the customer based on the dialogue content information is a negative reaction. Thus, second re-question information having attribute information having a different perspective from that of the question asked to the customer by the proposer can be presented to the proposer even in the case where an item liked by the customer cannot be determined from a response of the customer regarding the question asked to the customer by the proposer. Consequently, an item that is liked by the customer can be accurately determined from the response of the customer regarding the second re-question having a different perspective.

In the aforementioned proposal candidate presentation device, a degree of similarity indicating a mutual similarity may be set between the respective perspectives of the attribute information, and the re-question generator may decide the attribute information having the degree of similarity that is less than a predetermined value with respect to the perspective of the question, as the attribute information indicating a different perspective from the perspective of the question.

According to a configuration such as this, attribute information having a degree of similarity that is less than a predetermined value with respect to the perspective of the question included in the dialogue content is decided as attribute information indicating a different perspective from the perspective of the question included in the dialogue content. It is thereby possible to extract second re-question information representing a question having a perspective that is similar to an extent, from among different perspectives.

Furthermore, the present disclosure can not only be realized as a proposal candidate presentation device provided with characteristic configurations such as the aforementioned, but can also be realized as a proposal candidate presentation method or the like for executing characteristic processing corresponding to the characteristic configurations provided in the proposal candidate presentation device. Furthermore, it is also possible for the present disclosure to be realized as a recording medium having recorded thereon a computer program that causes a computer to execute the characteristic processing included in a proposal candidate presentation method such as the aforementioned. Consequently, an effect similar to that of the aforementioned proposal candidate presentation device can be demonstrated also in the other aspects described below.

A proposal candidate presentation method according to another aspect of the present disclosure includes: acquiring biological data of a customer, and generating biological reaction information including the acquired biological data and first time information indicating a time at which the biological data was acquired; acquiring dialogue content between the customer and a proposer, and generating dialogue content information including dialogue information indicating the dialogue content and second time information indicating a time at which the dialogue content was acquired; determining whether a reaction of the customer regarding a question asked by the proposer is a positive reaction or a negative reaction, based on the biological reaction information, and determining whether the reaction of the customer regarding the question is a positive reaction or a negative reaction, based on the dialogue content information; generating proposal candidate information indicating at least one proposal for the customer, based on a response of the customer regarding the question, in a case where it is determined that a reaction of the customer based on the biological reaction information is a positive reaction and a reaction of the customer based on the dialogue content information is a positive reaction; and generating first re-question information indicating first re-question having a same perspective as a perspective of the question; in a case where the reaction of the customer based on the biological reaction information and the reaction of the customer based on the dialogue content information do not match.

A recording medium according to another aspect of the present disclosure has recorded thereon a proposal candidate presentation program that causes a computer to execute processing including: acquiring biological data of a customer, and generating biological reaction information including the acquired biological data and first time information indicating a time at which the biological data was acquired; acquiring dialogue content between the customer and a proposer, and generating dialogue content information including dialogue information indicating the dialogue content and second time information indicating a time at which the dialogue content was acquired; determining whether a reaction of the customer regarding a question asked by the proposer is a positive reaction or a negative reaction, based on the biological reaction information, and determining whether the reaction of the customer regarding the question is a positive reaction or a negative reaction, based on the dialogue content information; generating proposal candidate information indicating at least one proposal for the customer, based on a response of the customer regarding the question, in a case where it is determined that a reaction of the customer based on the biological reaction information is a positive reaction and a reaction of the customer based on the dialogue content information is a positive reaction; and generating first re-question information indicating first re-question having a same perspective as a perspective of the question, in a case where the reaction of the customer based on the biological reaction information and the reaction of the customer based on the dialogue content information do not match.

Also, it goes without saying a computer program such as the aforementioned can be distributed by way of a computer-readable non-transitory recording medium such as a CD-ROM or a communication network such as the Internet.

Furthermore, the present disclosure may be configured as a system in which some constituent elements of a proposal candidate presentation device according to an embodiment of the present disclosure and other constituent elements are distributed among a plurality of computers.

It should be noted that the embodiments described hereinafter are all intended to represent exemplary embodiments of the present disclosure. The numerical values, the shapes, the constituent elements, the steps, the order of the steps, and the like given in the following embodiments are examples and are not intended to restrict the present disclosure. Furthermore, from among the constituent elements in the following embodiments, constituent elements that are not mentioned in the independent claims indicating the most significant concepts are described as optional constituent elements. Furthermore, in all of the embodiments, it is also possible to combine the respective content thereof.

### Embodiments

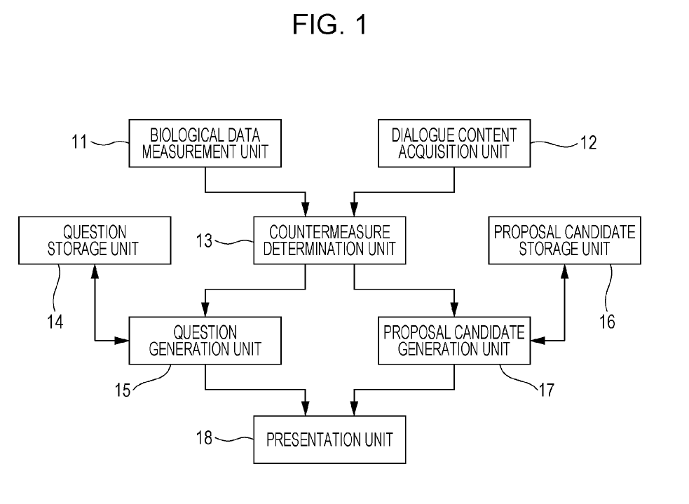

Hereinafter, embodiments of the present disclosure will be described with reference to the drawings. FIG. 1 is a block diagram depicting an example of a configuration of a proposal candidate presentation device according to an embodiment of the present disclosure. The proposal candidate presentation device depicted in FIG. 1 is provided with a biological data measurement unit 11, a dialogue content acquisition unit 12, a countermeasure determination unit 13, a question storage unit 14, a question generation unit 15, a proposal candidate storage unit 16, a proposal candidate generation unit 17, and a presentation unit 18.

The proposal candidate presentation device depicted in FIG. 1 is used when a proposal that corresponds to the preferences of a customer is made while a proposer engages in a dialogue with the customer. The proposal candidate presentation device depicted in FIG. 1 is configured from, for example, a tablet having a touch panel, a speaker, a microphone, a central processing unit (CPU), a read-only memory (ROM), a random-access memory (RAM), an auxiliary storage device, or the like. This proposal candidate presentation device presents proposal candidate information including at least one proposal for the customer; on the basis of dialogue content which includes a question asked to the customer by the proposer and a response of the customer regarding the question, and biological data of the customer. Together therewith; this proposal candidate presentation device presents first or second re-question information representing first or second re-question for the customer.

It should be noted that the configuration of the proposal candidate presentation device depicted in FIG. 1 is not particularly restricted to the aforementioned example of a tablet, and another device such as a mobile terminal, a smartphone for example; or a stationary or mobile personal computer may be used.

Furthermore, in the present embodiment, an example in which a proposer engages in a dialogue face-to-face with a customer is described; however, the present disclosure is not particularly restricted to this example, and can be similarly applied also in the case where the proposer engages in a dialogue with the customer via a network such as the Internet. In this case; the customer also uses a device such as a tablet or a personal computer. The device of the customer is provided with the aforementioned biological data measurement unit, a predetermined communication unit, or the like, the device of the proposer is provided with a predetermined communication unit or the like, and biological data or the like is transmitted from the device of the customer to the device of the proposer.

The biological data measurement unit 11 measures and acquires biological data of the customer at a time when the proposer asks a question to the customer. The biological data measurement unit 11 generates biological reaction information (sensing information) including the acquired biological data and biological time information indicating the time at which the biological data was acquired, and outputs the biological reaction information to the countermeasure determination unit 13. Brain waves, biogas, blood pressure, respiration, heartbeat, and/or body temperature or the like fall under biological data. For example, the biological data measurement unit 11 is provided with a sensor that measures human pulse waves in a non-contact manner using a high sensitive spread-spectrum millimeter-wave radar or the like, and detects the heart rate and heartbeat fluctuations of the customer.

It should be noted that the configuration of the biological data measurement unit 11 is not particularly restricted to this example, and the customer may attach a wearable terminal such as a smartwatch that measures biological data of the customer, and biological data may be acquired from the wearable terminal. In this case, the biological data measurement unit 11 constitutes a biological data acquisition unit that acquires measured biological data.

Furthermore, the data that is acquired by the biological data measurement unit 11 is also not particularly restricted to the aforementioned examples, and other biological data such as the speech, facial images, and blood oxygen concentration of the customer may be used as long as it is possible to determine whether a reaction of the customer that is described later on is a positive reaction or a negative reaction. In this case, the biological data measurement unit 11 is configured in such a way as to measure each item of biological data.

The dialogue content acquisition unit 12 acquires dialogue content between the customer and the proposer at a time when the proposer asks a question to the customer. The dialogue content acquisition unit 12 generates dialogue content information (exchange information) including dialogue information indicating the aforementioned dialogue content and dialogue time information indicating the time at which dialogue content was acquired, and outputs the dialogue content information to the countermeasure determination unit 13. Specifically, the dialogue content acquisition unit 12 is configured from a microphone or the like, and acquires speech of the dialogue content between the proposer and the customer. The dialogue content acquisition unit 12 subjects the acquired speech to speech recognition and generates text data that is made up of character strings, which is set as the dialogue content information together with the dialogue information that is made up of text data or the like indicating the dialogue content and the dialogue time information indicating the time at which the dialogue content was acquired.

It should be noted that the customer also uses a device such as a tablet or a personal computer in the case where the proposer engages in a dialogue with the customer via a network such as the Internet. The device of the customer is provided with a microphone, a predetermined communication unit, or the like, the device of the proposer is provided with a predetermined communication unit or the like, and speech data or the like including responses of the customer is transmitted from the device of the customer to the device of the proposer.

The countermeasure determination unit 13 determines whether a reaction of the customer regarding a question of the proposer is a positive reaction or a negative reaction, on the basis of the biological reaction information. Together therewith, the countermeasure determination unit 13 determines whether the reaction of the customer regarding the question of the proposer is a positive reaction or a negative reaction, on the basis of the dialogue content information. Specifically, as a first determination result, the countermeasure determination unit 13 determines whether the biological reaction information indicates a positive reaction or a negative reaction. Furthermore, as a second determination result, the countermeasure determination unit 13 determines whether the dialogue content information indicates a positive reaction or a negative reaction, combines the first determination result and the second determination result, and determines which from among proposal candidate presenting, first re-questioning, or second re-questioning is to be carried out as a countermeasure for the proposer.

Here, the following method can be used as an example of a method for determining whether the reaction of the customer is a positive reaction or a negative reaction.

First, as a method for determining a reaction of the customer using biological data, for example, the countermeasure determination unit 13 analyzes biological data acquired by the biological data measurement unit 11, and thereby estimates the emotion of customer (for example, see Japanese Patent No. 5257525). The countermeasure determination unit 13 determines a positive reaction in the case where the emotion of the customer is “pleasure” or “relaxation”, and determines a negative reaction in the case where the emotion of the customer is “anger” or “sadness”.

Specifically, in the case where heartbeat fluctuations acquired by the biological data measurement unit 11 are equal to or higher than a predetermined value, the emotion of the customer becomes “pleasure” or “relaxation”, and the countermeasure determination unit 13 determines a positive reaction. However, in the case where the heartbeat fluctuations acquired by the biological data measurement unit 11 are lower than the predetermined value, the emotion of the customer becomes “anger” or “sadness”, and the countermeasure determination unit 13 determines a negative reaction.

It should be noted that the method for determining a reaction of the customer using biological data is not particularly restricted to the aforementioned example, and various alterations are possible. For example, the emotion of the customer may be specified using the degree of wakefulness and degree of comfort of the customer generated from biological sensor values (see Japanese Patent No. 5735592), and the specified emotion may be associated with a positive reaction or a negative reaction.

Next, as a method for determining a reaction of the customer using dialogue information, for example, artificial intelligence such as deep learning is used for the countermeasure determination unit 13 to judge a positive reaction in the case where the response of the customer is interpreted as being “yes” and to determine a negative reaction in the case where the response of the customer is interpreted as being “no” from dialogue information. It should be noted that the method for determining a reaction of the customer using dialogue information is not particularly restricted to the aforementioned example, and various alterations are possible.

A plurality of questions for estimating the preferences of the customer are stored in the question storage unit 14, and tag information indicating the “perspective” of a question is assigned to each question. Specifically, the question storage unit 14 associates question information representing a question for estimating the preferences of the customer, and attribute information indicating the perspective of that question, and stores, in advance, a plurality of items of question information and a plurality of items of attribute information.

Here, the “perspective” means the point of view adopted when considering and judging a matter in an analysis, discussion, or the like. For example, in the case where the proposer proposes a trip plan for the customer in a travel agency as a consultant, “city name”, “architecture”, “dining”, “music”, “shopping”, or the like are tag information indicating “perspectives”. In this case, the attribute information of “city name” is associated with questions relating to “Rome”, “Naples”, “Venice”, or the like, the attribute information of “architecture” is associated with questions relating to the “Sagrada Familia”, the “Notre-Dame Cathedral”, the “Leaning Tower of Pisa”, or the like, the attribute information of “dining” is associated with questions relating to “French cuisine”, “Italian cuisine”, “Chinese cuisine”, or the like, and the attribute information of “music” is associated with questions relating to “opera”, “classical music”, “rock”, or the like. It should be noted that the attribute information is not particularly restricted to the aforementioned examples, and various alterations are possible according to the proposal content of the proposer.

The question generation unit 15 refers to the question storage unit 14, and creates a question for estimating the preferences of the customer, or creates a question that corresponds to a determination result that is output from the countermeasure determination unit 13.

First, as initial setting processing, the question generation unit 15 extracts question information representing a question to be an initial question, from the question information stored in the question storage unit 14 on the basis of information such as the past history and profile of the customer, and outputs the question information to the presentation unit 18. For example, in the case where information such as the past history and profile of the customer is stored in advance in a memory (not depicted) inside the question generation unit 15, the question generation unit 15 uses identification information or the like of the customer to read, from the memory, information such as the past history and profile of the customer being dealt with by the proposer, extracts question information to be the initial question on the basis of the information or the like that has been read, and outputs the question information to the presentation unit 18. It should be noted that the information such as the past history and profile of the customer is not particularly restricted to the aforementioned example, and this information may be stored in an external server or the like and obtained from the server or the like via a predetermined network.

Furthermore, in the case where the determination result of the countermeasure determination unit 13 is first re-questioning, the question generation unit 15 generates first re-question information indicating the same perspective as that of the previous question and outputs the first re-question information to the presentation unit 18. Here, the case where the determination result of the countermeasure determination unit 13 is first re-questioning means the case where the determination based on the biological reaction information is a positive reaction and the determination based on the dialogue content information is a negative reaction, or the case where the determination based on the biological reaction information is a negative reaction and the determination based on the dialogue content information is a positive reaction. Furthermore, in the case where the determination result of the countermeasure determination unit 13 is second re-questioning, the question generation unit 15 generates second re-question information indicating a different perspective from that of the previous question and outputs the second re-question information to the presentation unit 18. Here, the case where the determination result of the countermeasure determination unit 13 is second re-questioning means the case where the determination based on the biological reaction information is a negative reaction and the determination based on the dialogue content information is a negative reaction.

Specifically, the question generation unit 15 extracts question information having associated therewith attribute information indicating the same perspective as the perspective of the question included in the dialogue content, from the question information stored in the question storage unit 14 as first re-question information in the case where the reaction of the customer based on the biological reaction information and the reaction of the customer based on the dialogue content information do not match. The question generation unit 15 thereby generates first re-question information representing first re-question having the same perspective as that of the question included in the dialogue content.

Here, the attribute information may have a degree of similarity between the perspective of that attribute information and the perspective of other attribute information. In this case, the question generation unit 15 decides attribute information that has a degree of similarity that is equal to or greater than a predetermined value with respect to the perspective of the question included in the dialogue content, as attribute information indicating the same perspective as the perspective of the question included in the dialogue content. In addition, the question generation unit 15 extracts the question information associated with the decided attribute information, from the question information stored in the question storage unit 14 as first re-question information.

For example, in the case where the proposer proposes a trip plan for the customer in a travel agency as a consultant, it is assumed that “city name”, “dining”, “music”, and “shopping” are set as attribute information. In this case, when the degree of similarity between “city name” and “dining” is 0.8, the degree of similarity between “city name” and “music” is 0.4, the degree of similarity between “city name” and “shopping” is 0.6, and a determination reference value is 0.7, attribute information with which the degree of similarity is equal to or greater than 0.7 may be decided as attribute information having the same perspective. In this case, the degree of similarity between “city name” and “dining” is 0.8, which is equal to or greater than the determination reference value of 0.7, and therefore the perspective of question information having “city name” as attribute information becomes the same as the perspective of question information having “dining” as attribute information. It should be noted that the attribute information and the determination reference value are not particularly restricted to the aforementioned example, and various alterations are possible according to the proposal content of the proposer.

Furthermore, it is assumed that the case where the reaction of the customer based on the biological reaction information and the reaction of the customer based on the dialogue content information do not match is repeated a predetermined number of times with respect to questions represented by the first re-question information. In this case, the question generation unit 15 extracts question information having associated therewith attribute information indicating a different perspective from the perspective of the question included in the dialogue content, from the question information stored in the question storage unit 14 as second re-question information. The question generation unit 15 thereby generates second re-question information representing second re-question having a different perspective from the perspective of the question included in the dialogue content.

Furthermore, it is assumed that the reaction of the customer based on the biological reaction information is a negative reaction and that the reaction of the customer based on the dialogue content information is a negative reaction. In this case, the question generation unit 15 extracts question information having associated therewith attribute information indicating a different perspective from the perspective of the question included in the dialogue content, from the question information stored in the question storage unit 14 as second re-question information. The question generation unit 15 thereby generates second re-question information representing second re-question having a different perspective from that of the question included in the dialogue content.

Here, the attribute information may have a degree of similarity between the perspective of that attribute information and the perspective of other attribute information. In this case, the question generation unit 15 decides attribute information that has a degree of similarity that is less than a predetermined value with respect to the perspective of the question included in the dialogue content, as attribute information indicating a different perspective from the perspective of the question included in the dialogue content. In addition, the question generation unit 15 extracts the question information associated with the decided attribute information, from the question information stored in the question storage unit 14 as second re-question information.

For example, in the case where the proposer proposes a trip plan for the customer in a travel agency as a consultant, it is assumed that “city name”, “dining”, “music”, and “shopping” are set as attribute information. In this case, when the degree of similarity between “city name” and “dining” is 0.8, the degree of similarity between “city name” and “music” is 0.4, the degree of similarity between “city name” and “shopping” is 0.6, and the determination reference value is 0.5, attribute information with which the degree of similarity is less than 0.5 may be decided as attribute information having a different perspective. In this case, the degree of similarity between “city name” and “music” is 0.4, which is less than the determination reference value of 0.5, and therefore the perspective of question information having “city name” as attribute information is different from the perspective of question information having “music” as attribute information.

It should be noted that the method for acquiring question information, attribute information, and the like is not particularly restricted to the aforementioned example. For example, the question storage unit 14 may be omitted, and the question information, attribute information, and the like may be stored in an external server or the like and obtained from the server or the like via a predetermined network.

The proposal candidate storage unit 16 stores proposal candidate information including at least one proposal that has been set in advance with respect to each of a plurality of questions that are asked to the customer by the proposer.

On the basis of question information representing a question for which it has been determined that the reaction of the customer based on the biological reaction information is a positive reaction and the reaction of the customer based on the dialogue content information is a positive reaction, the proposal candidate generation unit 17 generates proposal candidate information including a proposal that is suitable for the customer who has expressed a positive reaction to that question, and outputs the proposal candidate information to the presentation unit 18.

Specifically, the proposal candidate generation unit 17 extracts proposal candidate information that has been set with respect to the question asked to the customer by the proposer, from the proposal candidate storage unit 16 in the case where the reaction of the customer based on the biological reaction information is a positive reaction and the reaction of the customer based on the dialogue content information is a positive reaction. The proposal candidate generation unit 17 thereby generates proposal candidate information based on the response of the customer regarding the question asked to the customer by the proposer.

It should be noted that the method for acquiring proposal candidate information or the like is not particularly restricted to the aforementioned example. For example, the proposal candidate storage unit 16 may be omitted, and the proposal candidate information or the like may be stored in an external server or the like and obtained from the server or the like via a predetermined network.

The presentation unit 18, for example, is configured from a display device or the like, and displays proposal candidate information including one or more proposals to the proposer. Furthermore, the presentation unit 18 displays the first re-question information having the same perspective as the question included in the dialogue content or the second re-question information having a different perspective therefrom. Here, in the case where proposal candidate information including one proposal is displayed, the proposer proposes that proposal to the customer. Furthermore, in the case where proposal candidate information including a plurality of proposals is displayed, the proposer selects one from among the plurality of proposals on the basis of a judgment made by the proposer, and proposes the selected proposal to the customer. It should be noted that the configuration of the presentation unit 18 is not particularly restricted to the aforementioned example. For example, an audio output device such as a speaker, an earphone, or the like may be used, and in this case, the proposal candidate information is presented to the proposer by means of audio.

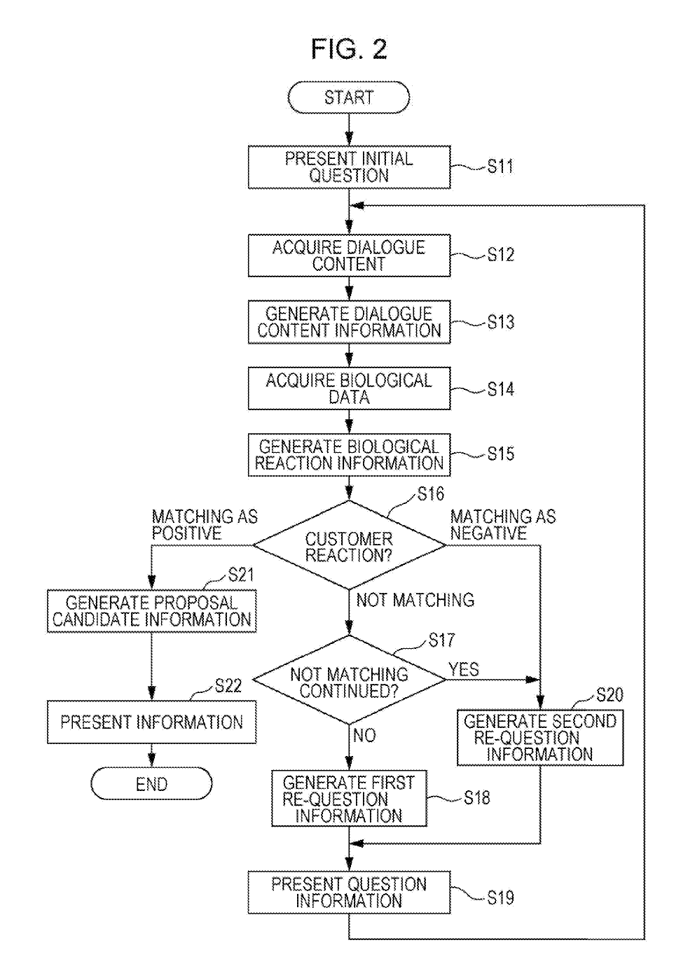

Next, proposal candidate presentation processing carried out by the proposal candidate presentation device configured as mentioned above will be described. FIG. 2 is a flowchart depicting an example of proposal candidate presentation processing carried out by the proposal candidate presentation device depicted in FIG. 1.

The proposer engages in an initial conversation with the customer, and identification information of the customer is set in the question generation unit 15. As depicted in FIG. 2, first, as initial setting processing, the question generation unit 15 extracts question information representing a question that is to be the initial question, from the question information stored in the question storage unit 14, on the basis of information such as the past history and profile of the customer, and outputs the question information to the presentation unit 18. The presentation unit 18 displays the question information representing the question that is to be the initial question (step S11).

Next, the dialogue content acquisition unit 12 acquires dialogue content between the customer and the proposer (step S12). The dialogue content acquisition unit 12 generates dialogue content information including dialogue information indicating this dialogue content and dialogue time information indicating the time at which the dialogue content was acquired, and outputs the dialogue content information to the countermeasure determination unit 13 (step S13).

Next, the biological data measurement unit 11 acquires the pulse of the customer, for example, as biological data (step S14). The biological data measurement unit 11 generates biological reaction information including the acquired biological data and biological time information indicating the time at which the biological data was acquired, and outputs the biological reaction information to the countermeasure determination unit 13 (step S15).

It should be noted that the order of the processing of steps S12 and S13 and the processing of steps S14 and S15 are not particularly restricted to the aforementioned example. For example, the processing of steps S12 and S13 may be executed after the processing of steps S14 and S15 or may be executed in parallel.

Next, the countermeasure determination unit 13 determines whether a reaction of the customer regarding the question of the proposer is a positive reaction or a negative reaction, on the basis of the biological reaction information that has been input. Together therewith, the countermeasure determination unit 13 determines whether the reaction of the customer regarding the question of the proposer is a positive reaction or a negative reaction, on the basis of the dialogue content information that has been input. In addition, the countermeasure determination unit 13 determines which of the following states (1) to (3) is in effect (step 316). (1) The determination based on the biological reaction information is a positive reaction and the determination based on the dialogue content information is a positive reaction (the determination results match as positive). (2) The determination based on the biological reaction information is a positive reaction and the determination based on the dialogue content information is a negative reaction, or the determination based on the biological reaction information is a negative reaction and the determination based on the dialogue content information is a positive reaction (the determination results do not match). (3) The determination based on the biological reaction information is a negative reaction and the determination based on the dialogue content information is a negative reaction (the determination results match as negative).

In the case of the aforementioned (2) (in the case where the determination results do not match in step S16), the countermeasure determination unit 13 notifies the question generation unit 15 that the determination results do not match and first re-question is to be carried out. The question generation unit 15 counts the number of times that the determination results have not matched, and judges whether or not the number of times that the determination results have not matched has continued for a predetermined number of times (for example, three times) (step S17).

If the case where the determination results do not match has not continued for the predetermined number of times (no in step S17), the question generation unit 15 extracts question information having associated therewith attribute information indicating the same perspective as the perspective of the question included in the dialogue content, from the question information stored in the question storage unit 14 as first re-question information. In addition, the question generation unit 15 generates first re-question information representing first re-question having the same perspective as that of the question included in the dialogue content, and outputs the first re-question information to the presentation unit 18 (step S18).

Next, the presentation unit 18 displays the first re-question information having the same perspective as the perspective of the question included in the dialogue content, and, thereafter, processing transitions to step 312 in order to prepare for the next dialogue (step S19). Consequently, in the case where the determination results based on the biological reaction information and the dialogue content information do not match and the preferences of the customer cannot be determined, the proposer is able to carry out re-question in accordance with the first re-question information having the same perspective as the perspective of the immediately preceding question, and is able to accurately confirm the preferences of the customer.

However, if the case where the determination results do not match has continued for the predetermined number of times (yes in step 317), the question generation unit 15 extracts question information having associated therewith attribute information indicating a different perspective from the perspective of the question included in the dialogue content, from the question information stored in the question storage unit 14 as second re-question information. In addition, the question generation unit 15 generates second re-question information representing second re-question having a different perspective from that of the question included in the dialogue content, from the extracted question information, and outputs the second re-question information to the presentation unit 18 (step S20).

Next, the presentation unit 18 displays the second re-question information having a different perspective from the perspective of the question included in the dialogue content, and, thereafter, processing transitions to step S12 in order to prepare for the next dialogue (step S19). Consequently, when the case where the determination results based on the biological reaction information and the dialogue content information do not match continues and the preferences of the customer cannot be determined by means of a question having the same perspective, the proposer is able to carry out re-question in accordance with the second re-question information having a different perspective from the perspective of the question, and is able to accurately confirm the preferences of the customer by means of a new question.

Furthermore, in the case of the aforementioned (3) (in the case where the determination results match as negative in step S16), the countermeasure determination unit 13 notifies the question generation unit 15 that the determination results match as negative and second re-question is to be carried out. The question generation unit 15 extracts question information having associated therewith attribute information indicating a different perspective from the perspective of the question included in the dialogue content, from the question information stored in the question storage unit 14 as second re-question information. In addition, the question generation unit 15 generates second re-question information representing second re-question having a different perspective from that of the question included in the dialogue content, from the extracted question information, and outputs the second re-question information to the presentation unit 18 (step 320).

Next, the presentation unit 18 displays the second re-question information having a different perspective from the perspective of the question included in the dialogue content, and, thereafter, processing transitions to step S12 in order to prepare for the next dialogue (step S19). Consequently, in the case where the determination results based on the biological reaction information and the dialogue content information match as negative and the preferences of the customer cannot be determined by means of a question having the same perspective, the proposer is able to carry out re-question in accordance with the second re-question information having a different perspective from the perspective of the question, and is able to accurately confirm the preferences of the customer by means of a new question.

In addition, in the case of the aforementioned (1) (in the case where the determination results match as positive in step S16), the countermeasure determination unit 13 notifies the proposal candidate generation unit 17 that the determination results match as positive and a proposal candidate is to be presented. The proposal candidate generation unit 17 extracts proposal candidate information that has been set with respect to the question asked to the customer by the proposer, from the proposal candidate storage unit 16. In addition, the proposal candidate generation unit 17 generates the best proposal candidate information with respect to the response of the customer regarding the question asked to the customer by the proposer, and outputs the proposal candidate information to the presentation unit 18 (step S21).

Next, the presentation unit 18 displays the best proposal candidate information with respect to the response of the customer regarding the question asked to the customer by the proposer, and processing ends (step S22). Consequently, in the case where the determination results based on the biological reaction information and the dialogue content information match as positive and the preferences of the customer have been accurately determined, the proposer is able to provide the best proposal that is suitable for the preferences of the customer.

It should be noted that, in the aforementioned description, proposal candidate information was presented in the case where the determination results based on the biological reaction information and the dialogue content information have matched as positive with respect to one question; however, the present disclosure is not particularly restricted to this example. For example, various alterations are possible such as proposal candidate information being presented in the case where the determination results based on the biological reaction information and the dialogue content information have all matched as positive with respect to a plurality of predetermined questions.

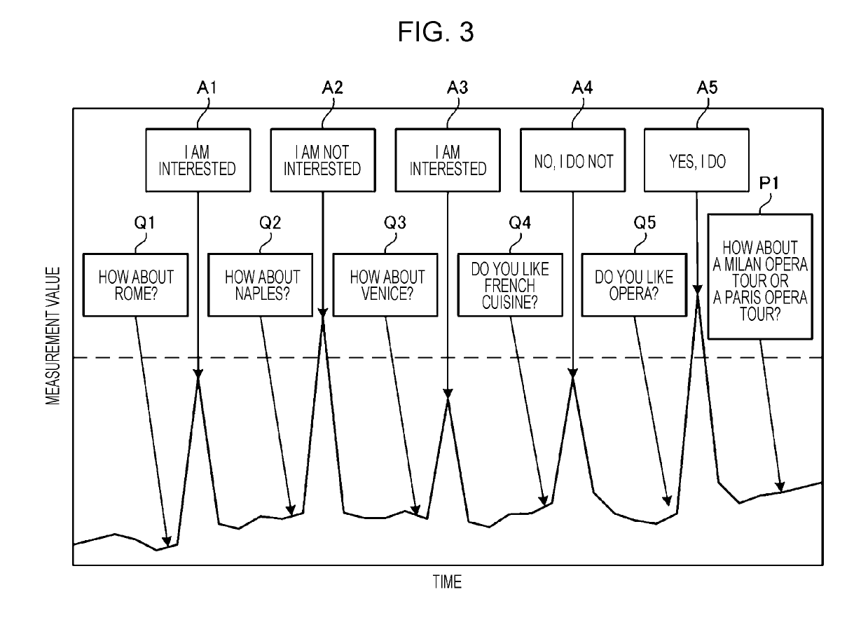

Next, a specific example of the first re-question information, the second re-question information, and the proposal candidate information presented as a result of the aforementioned proposal candidate presentation processing will be described with the case where the proposer proposes a trip plan for the customer in a travel agency as a consultant as an example. FIG. 3 is a drawing depicting an example of summary information created from the biological reaction information and the dialogue content information.

The summary information depicted in FIG. 3 indicates an example of a display screen displayed on the presentation unit 18, and the proposer engages in a dialogue with the customer while looking at this display screen. In the summary information depicted in FIG. 3, the horizontal axis indicates time and the vertical axis indicates measurement values for biological data (for example, heartbeat fluctuation values in arbitrary units). Furthermore, the solid polygonal line represents changes in the biological data, the dashed line is a threshold value at which it is determined that the biological data constitutes a positive reaction if equal to or greater than that value, and summaries of dialogue content at times at which the biological data changes are superimposed and displayed.

First, as an initial question, for example, the question generation unit 15 extracts question information with which “Rome” is proposed, and the presentation unit 18 displays “How about Rome?” Q1 as the initial question. In accordance with this display, the proposer inquires “How about Rome′?”. At such time, in the case where the customer has responded with “I am interested”, the customer response “I am interested” A1 is displayed superimposed on the biological data from at this time. The measurement value for the biological data from at this time is less than the threshold value indicating a positive reaction.

In this case, the countermeasure determination unit 13 judges that the determination based on the biological reaction information is a negative reaction and the determination based on the dialogue content information is a positive reaction. Furthermore, the number of times that the determination results do not match is 1, and therefore the question generation unit 15 extracts question information proposing “Naples”, for example, as first re-question information, from among question information having associated therewith the attribute information “city name” indicating the same perspective as the perspective of the question regarding “Rome”. The presentation unit 18 displays “How about Naples?” Q2 as the first re-question information.

Next, when the proposer inquires “How about Naples?” and the customer responds with “I am not interested”, the customer response “I am not interested” A2 is displayed superimposed on the biological data from at this time. The measurement value for the biological data from at this time is equal to or greater than the threshold value indicating a positive reaction.

In this case, the countermeasure determination unit 13 judges that the determination based on the biological reaction information is a positive reaction and the determination based on the dialogue content information is a negative reaction. Furthermore, the number of times that the determination results have not matched is 2, and therefore the question generation unit 15 extracts question information inquiring about “Venice”, for example, as first re-question information, from among question information having associated therewith the attribute information “city name” indicating the same perspective as the perspective of the question regarding “Naples”. The presentation unit 18 displays “How about Venice?” Q3 as the first re-question information.

Next, when the proposer inquires “How about Venice?” and the customer responds with “I am interested”, the customer response “I am interested” A3 is displayed superimposed on the biological data from at this time. The measurement value for the biological data from at this time is less than the threshold value indicating a positive reaction.

In this case, the countermeasure determination unit 13 judges that the determination based on the biological reaction information is a negative reaction and the determination based on the dialogue content information is a positive reaction. Furthermore, the number of times that the determination results have not matched is 3, and therefore the question generation unit 15 extracts question information inquiring about “French cuisine”, for example, as second re-question information, from among question information having associated therewith the attribute information “dining”, for example, indicating a different perspective from the perspective of the question regarding “Venice”. The presentation unit 18 displays “Do you like French cuisine?” Q4 as the second re-question information.

Next, when the proposer inquires “Do you like French cuisine?” and the customer responds with “No, I do not”, the customer response “No, I do not” A4 is displayed superimposed on the biological data from at this time. The measurement value for the biological data from at this time is less than the threshold value indicating a positive reaction.

In this case, the countermeasure determination unit 13 judges that the determination based on the biological reaction information is a negative reaction and the determination based on the dialogue content information is a negative reaction. Consequently, the question generation unit 15 extracts question information inquiring about “opera”, for example, as second re-question information, from among question information having associated therewith the attribute information “music”, for example, indicating a different perspective from the perspective of the question regarding “French cuisine”. The presentation unit 18 displays “Do you like opera?” Q5 as the second re-question information.

Next, when the proposer inquires “Do you like opera?” and the customer responds with “Yes, I do”, the customer response “Yes, I do” A5 is displayed superimposed on the biological data from at this time. The measurement value for the biological data from at this time is equal to or greater than the threshold value indicating a positive reaction.

In this case, the countermeasure determination unit 13 judges that the determination based on the biological reaction information is a positive reaction and the determination based on the dialogue content information is a positive reaction. Consequently, the proposal candidate generation unit 17 extracts proposal candidate information that has been set with respect to the question regarding “opera” asked to the customer by the proposer, for example, proposal candidate information proposing a “Milan opera tour” and a “Paris opera tour”, from the proposal candidate storage unit 16. The presentation unit 18 displays “How about a Milan opera tour or a Paris opera tour?” P1 proposing a “Milan opera tour” and a “Paris opera tour”, as proposal candidate information.

Lastly, the proposer confirms the proposal candidate information P1 proposing a “Milan opera tour” and a “Paris opera tour”, and, in the case of having selected the “Milan opera tour” based on his or her own judgment, is able to make the proposal “How about a Milan opera tour?”.

As mentioned above, in the present embodiment, in consulting work and concierge work in hotels and the like in which products such as trips are proposed and sold to a customer by a proposer, in the case where the reaction of the customer based on the biological reaction information and the reaction of the customer based on the dialogue content information are both positive reactions, it is possible for an item that is liked by the customer to be reliably determined from the response of the customer regarding a question asked to the customer by the proposer. In addition, by generating proposal candidate information based on this response of the customer, proposal candidate information including a proposal that is liked by the customer can be appropriately presented to the proposer.

Furthermore, the proposer is able to carry out first re-question having the same perspective using first re-question information, even in the case where the reaction of the customer based on the biological reaction information and the reaction of the customer based on the dialogue content information do not match and an item liked by the customer cannot be accurately determined from the response of the customer regarding a question asked to the customer by the proposer. Thus, in the case where the reaction of the customer based on the biological reaction information and the reaction of the customer based on the dialogue content information regarding this first re-question are both positive reactions, an item liked by the customer can be accurately determined from the response of the customer regarding the first re-question having the same perspective, and proposal candidate information including a proposal that is liked by the customer can be appropriately presented to the proposer.

Furthermore, second re-question information representing second re-question having a different perspective from the perspective of the question included in the dialogue content is generated when the case where the reaction of the customer based on the biological reaction information and the reaction of the customer based on the dialogue content information do not match has been repeated a predetermined number of times with respect to questions represented by the first re-question information. Thus, second re-question information having a different perspective from that of the questions asked to the customer by the proposer can be presented to the proposer, and an item liked by the customer can be accurately determined from the responses of the customer regarding the second re-question of the different perspective, in the case where a state has continued in which an item liked by the customer cannot be accurately determined from responses of the customer regarding questions asked to the customer by the proposer.

In addition, second re-question information representing second re-question having a different perspective from that of the question included in the dialogue content is generated in the case where the reaction of the customer based on the biological reaction information is a negative reaction and the reaction of the customer based on the dialogue content information is a negative reaction. Thus, the proposer is able to carry out second re-question having a different perspective using the second re-question information, even in the case where an item liked by the customer cannot be accurately determined from responses of the customer regarding questions asked to the customer by the proposer.

Consequently, an item liked by the customer can be accurately determined from the response of the customer regarding the second re-question having a different perspective, and proposal candidate information including a proposal that is liked by the customer can be appropriately presented to the proposer, in the case where the reaction of the customer based on the biological reaction information and the reaction of the customer based on the dialogue content information regarding this second re-question are both positive reactions.

As a result, proposal candidate information including a proposal that corresponds to the preferences of the customer can be presented to the proposer even in the case where there is a difference between a reaction determined from a response of the customer regarding a question and a reaction determined from biological data of the customer regarding the question.

Hereinabove, a proposal candidate presentation device according to an aspect of the present disclosure has been described on the basis of the aforementioned embodiment; however, the present disclosure is not restricted to the aforementioned embodiment. Modes in which various modifications conceived by a person skilled in the art have been implemented in the present embodiment, and modes constructed by combining the constituent elements in different embodiments may also be included within the scope of the present disclosure provided they do not depart from the purpose of the present disclosure.

With a proposal candidate presentation device, a proposal candidate presentation method, and a recording medium having recorded thereon a proposal candidate presentation program according to the present disclosure, when a proposer carries out consulting work and concierge work with respect to a customer face-to-face or via the Internet in various facilities, proposal candidate information including a proposal that corresponds to the preferences of the customer can be presented to the proposer even in the case where there is a difference between a reaction determined from a response of the customer regarding a question and a reaction determined from biological data of the customer regarding the question. Consequently, the present disclosure is useful as a proposal candidate presentation device, a proposal candidate presentation method, and a recording medium having recorded thereon a proposal candidate presentation program which present proposal candidate information including at least one proposal for a customer on the basis of dialogue content including a question asked to the customer by a proposer and a response of the customer regarding the question.

What is claimed is:

1. A proposal candidate presentation device, comprising:
a biological reaction information generator that acquires biological data of a customer, and generates biological reaction information including the biological data and first time information indicating a time at which the biological data was acquired;
a dialogue content information generator that acquires dialogue content between the customer and a proposer, and generates dialogue content information including dialogue information indicating the dialogue content and second time information indicating a time at which the dialogue content was acquired;
a countermeasure determiner that determines whether a reaction of the customer regarding a question asked by the proposer is a positive reaction or a negative reaction, based on the biological reaction information, and determines whether the reaction of the customer regarding the question is a positive reaction or a negative reaction, based on the dialogue content information;
a proposal candidate generator that generates proposal candidate information indicating at least one proposal for the customer, based on a response of the customer regarding the question, in a case where it is determined that a reaction of the customer based on the biological reaction information is a positive reaction and a reaction of the customer based on the dialogue content information is a positive reaction; and
a re-question generator that generates first re-question information indicating first re-question having a same perspective as a perspective of the question, in a case where the reaction of the customer based on the biological reaction information and the reaction of the customer based on the dialogue content information do not match.

2. The proposal candidate presentation device according to claim 1, further comprising:
a proposal candidate storer that stores the proposal candidate information, which is set in advance with respect to the question, wherein
the proposal candidate generator extracts the proposal candidate information that has been set with respect to the question, from the proposal candidate storer, in a case where it is determined that the reaction of the customer based on the biological reaction information is a positive reaction and the reaction of the customer based on the dialogue content information is a positive reaction.

3. The proposal candidate presentation device according to claim 1, further comprising:
a question storer that stores, in association with each other, question information indicating each of a plurality of questions including the question, and attribute information indicating a perspective of each of the plurality of questions, wherein
the re-question generator extracts the question information associated with the attribute information indicating a same perspective as the perspective of the question, from the stored question information as the first re-question information, in a case where the reaction of the customer based on the biological reaction information and the reaction of the customer based on the dialogue content information do not match.

4. The proposal candidate presentation device according to claim 3, wherein
a degree of similarity indicating a mutual similarity is set between the respective perspectives of the attribute information, and
the re-question generator decides the attribute information having the degree of similarity that is equal to or greater than a predetermined value with respect to the perspective of the question, as the attribute information indicating the same perspective as the perspective of the question.

5. The proposal candidate presentation device according to claim 1, wherein
the re-question generator generates second re-question information indicating second re-question having a different perspective from the perspective of the question included in the dialogue content, when a case where the reaction of the customer based on the biological reaction information and the reaction of the customer based on the dialogue content information do not match has been repeated a predetermined number of times with respect to the first re-question indicated by the first re-question information.

6. The proposal candidate presentation device according to claim 5, further comprising:
a question storer that stores, in association with each other, question information indicating each of a plurality of questions including the question, and attribute information indicating a perspective of each of the plurality of questions, wherein
the re-question generator extracts the question information associated with the attribute information indicating a different perspective from the perspective of the question, from the stored question information as the second re-question information, when a case where the reaction of the customer based on the biological reaction information and the reaction of the customer based on the dialogue content information do not match has been repeated a predetermined number of times with respect to the first re-question indicated by the first re-question information.

7. The proposal candidate presentation device according to claim 1, wherein
the re-question generator generates second re-question information indicating second re-question having a different perspective from the perspective of the question, in a case where the reaction of the customer based on the biological reaction information is a negative reaction and the reaction of the customer based on the dialogue content information is a negative reaction.

8. The proposal candidate presentation device according to claim 7, further comprising:
a question storer that stores, in association with each other, question information indicating each of a plurality of questions including the question, and attribute information indicating a perspective of each of the plurality of questions, wherein
the re-question generator extracts the question information associated with the attribute information indicating a different perspective from the perspective of the question, from the stored question information as the second re-question information, in a case where the reaction of the customer based on the biological reaction information is a negative reaction and the reaction of the customer based on the dialogue content information is a negative reaction.

9. The proposal candidate presentation device according to claim 6, wherein
a degree of similarity indicating a mutual similarity is set between the respective perspectives of the attribute information, and
the re-question generator decides the attribute information having the degree of similarity that is less than a predetermined value with respect to the perspective of the question, as the attribute information indicating a different perspective from the perspective of the question.

10. The proposal candidate presentation device according to claim 1, further comprising:
a sensor that detects the biological data of the customer.

11. The proposal candidate presentation device according to claim 1, further comprising:
a microphone that detects the dialogue content between the customer and the proposer.

12. A proposal candidate presentation method, including:
acquiring biological data of a customer, and generating biological reaction information including the acquired biological data and first time information indicating a time at which the biological data was acquired;
acquiring dialogue content between the customer and a proposer, and generating dialogue content information including dialogue information indicating the dialogue content and second time information indicating a time at which the dialogue content was acquired;
determining whether a reaction of the customer regarding a question asked by the proposer is a positive reaction or a negative reaction, based on the biological reaction information, and determining whether the reaction of the customer regarding the question is a positive reaction or a negative reaction, based on the dialogue content information;
generating proposal candidate information indicating at least one proposal for the customer, based on a response of the customer regarding the question, in a case where it is determined that a reaction of the customer based on the biological reaction information is a positive reaction and a reaction of the customer based on the dialogue content information is a positive reaction; and
generating first re-question information indicating first re-question having a same perspective as a perspective of the question, in a case where the reaction of the customer based on the biological reaction information and the reaction of the customer based on the dialogue content information do not match.
